(19) United States
(12) Patent Application Publication
(10) Pub. No.: US 2008/0073119 A1
(43) Pub. Date: Mar. 27, 2008

(54) Electrical Cable Having An Orientation Marker

(76) Inventors: Johannes Will, Bruchsal (DE); Volker Seipel, Bensheim (DE); Hans-Dieter Pfeifer, Lautertal (DE); Barbara Pfeifer, Lautertal (DE)

Correspondence Address: BARLEY SNYDER, LLC, 1000 WESTLAKES DRIVE, SUITE 275, BERWYN, PA, 19312, US

(21) Appl. No.: 11/853,321

(22) Filed: Sep. 11, 2007

(30) Foreign Application Priority Data
Sep. 22, 2006 (DE) 102006044939.8

(51) Int. Cl. H01B 7/36; H01R 3/00

(52) U.S. Cl. 174/70 R; 439/488

(57) ABSTRACT

An electrical cable is disclosed, for example, a flat electrical cable in which a marker on one side of the cable or in which a marker of a subsequent orientation of the cable may be formed without additional costs. The electrical cable has an orientation marker which has at least one recess in the electrical cable and which is provided in the electrical cable so as to facilitate correct alignment of the electrical cable during installation and/or manufacture of the electrical cable.

### CROSS-REFERENCED TO RELATED APPLICATIONS

This application claims the benefit of the filing date under 35 U.S.C. § 119(a)-(d) of German Patent Application No. DE 10 2006 044 939.8, filed Sep. 22, 2006.

### FIELD OF THE INVENTION

The invention relates to an electrical cable, and more particularly to an electrical cable having an orientation marker. The invention further relates to an electrical rotational transmitter, especially a coil spring for a motor vehicle steering system comprising a flexible flat electrical cable according to the invention.

### BACKGROUND

The use of film-insulated conductors or the use of flat cables is suitable, in particular, for applications in which the overall space and weight of conventional electrical cables have to be reduced. Such cables are therefore widely used in the automotive industry, the aerospace and electrical industries.

Electrical and/or electronic devices/components in these fields continue to be further integrated. In combination with rising power requirements for all of the components as a whole, this reduces, as a result of larger line cross-sections, the amount of overall space available. With the same possibilities for the transmission of power and/or signals as offered by conventional round copper cables, flat cables, in particular, take up much less space and are at the same time lighter. This technology looks set to expand rapidly beyond the previous applications of flat cables of this type, and market trends have given rise to a high degree of automation in the manufacture of flexible flat cables.

Electrical cables for the transmission of power or signals, especially cables for simultaneous power and signal transmission such as, for example, flexible flat cables for electrical rotational transmitters, have to be visually marked. These visual markings ensure that the cable is installed or manufactured in the correct orientation or position. This ensures that a respective electrical conductor of the cable is electrically connected at the correct terminal. This is the case, in particular, in cables, the conductors of which are individually configured for a specific application. This may be the case, for example, with a coil spring for a motor vehicle steering wheel, wherein a flexible flat cable contained in the coil spring has to be configured in such a way that it transmits signals in a flat conductor contained and transmits power in another flat conductor contained, for example for an electrical trigger pulse of a capsule for triggering an airbag.

In order to allow flat cables configured specifically for an application to be installed or manufactured with correct orientation, color markings are applied to the cables so as to allow them subsequently to be positioned accordingly. Problems associated with a marker of this type, for example an edge of the flat cable using a printed line, include firstly an additional marking step which, in manufacture, increases the unit price of the flat cable. A further problem associated with color markers is that the marker can become worn over time. This is problematic in the case of an insulating layer made of polyethylene because the wax-like surface of the polyethylene and the absence of polar groups in the molecular structure impair adhesion of a marker material.

### SUMMARY

An object of the invention, among others is therefore to provide an improved electrical cable, such as a flexible flat cable having a marker on one side of the cable or a marker of a subsequent orientation of the cable without additional costs.

An electrical cable, such as a flat flexible cable has a recess being provided in the cable so as to allow correctly oriented positioning during installation and/or manufacture of the cable. The recess serves as an orientation marker, which may be permanent, to provide positioning of a cable or flat cable.

### BRIEF DESCRIPTION OF THE DRAWINGS

The invention will be described hereinafter in greater detail using embodiments and with reference to the enclosed drawings, in which:

FIG. 1 is a plan view of a plurality of orientation markers on an flat electrical cable according to the invention, and;

FIG. 2 is a perspective view of the flat electrical cable according to the invention comprising a plurality of orientation markers.

### DETAILED DESCRIPTION OF THE EMBODIMENT(S)

The invention will now be described in greater detail with reference to a flexible, flat electrical cable 1, hereinafter referred to as a flat cable 1, for a motor vehicle coil spring. However, is not to be restricted to a flat cable of this type but rather relates to electrical cables in general requiring correctly orientated installation or correctly oriented assembly/manufacture.

In the case of flexible flat cables (FFCs), a distinction is drawn between extruded flexible flat cables (exFCs) and flexible laminated cables (FLCs). Also included in this field are what are known as flexible printed circuits (FPCs).

Flexible laminated cables consist of preferably a plurality of electrical flat conductors 20 which are arranged parallel to one another between two electrically insulating cover sheets. These cover sheets are conventionally joined together using an adhesive and enclose between them the flat conductors 20 of the flat cable 1. The flat conductors 20 are set apart from one another and electrically insulated from one another by the adhesive and/or the insulating cover sheets.

Extruded flexible flat cables 1 consist preferably of foil-like copper strips which are electrically insulated from one another using a thin, adhesive-free plastics material layer and are joined together in an extrusion process to form a single strip. The advantage of extruded flat cables 1 is that they contain no adhesive, allowing flat cables 1 to be stripped without residue in the window 40. The absence of an adhesive also means that such cables are more environmentally friendly to manufacture and dispose of.

Flexible flat cables 1 are used as connection cables in a large number of applications, especially in applications in which little overall space is available. In addition, flexible flat cables 1 are preferably used in applications in which two elements which can be moved in opposing directions are electrically connected to each other, such as is the case, for example, with an electrical rotational transmitter, such as a coil spring on a motor vehicle steering system, or a movable print head.

As flat cables 1 are used for transmitting power and, preferably in another electrical conductor of the cable, also for transmitting signals (higher electrical currents being required for transmitting power, with lower transmission quality), the flat cable 1 has to be installed, fitted or manufactured correctly oriented or in a correct position in a component.

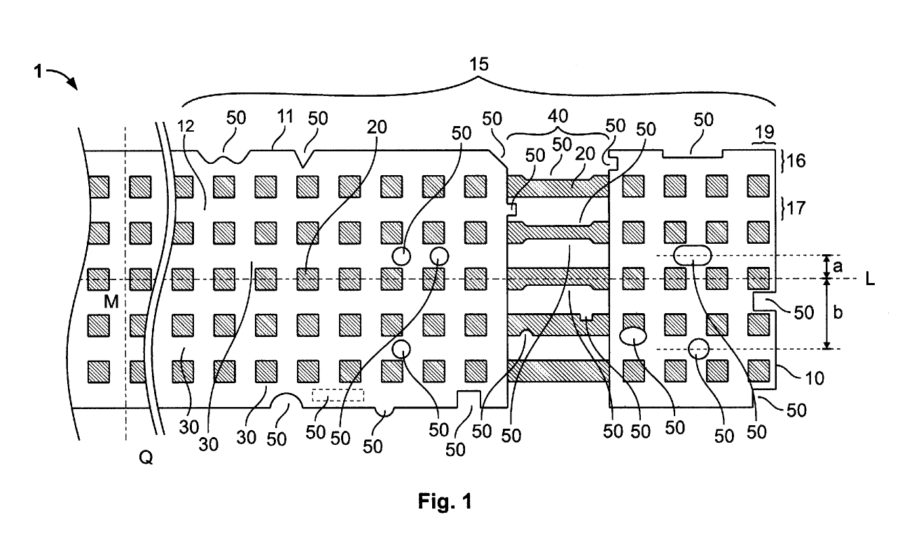

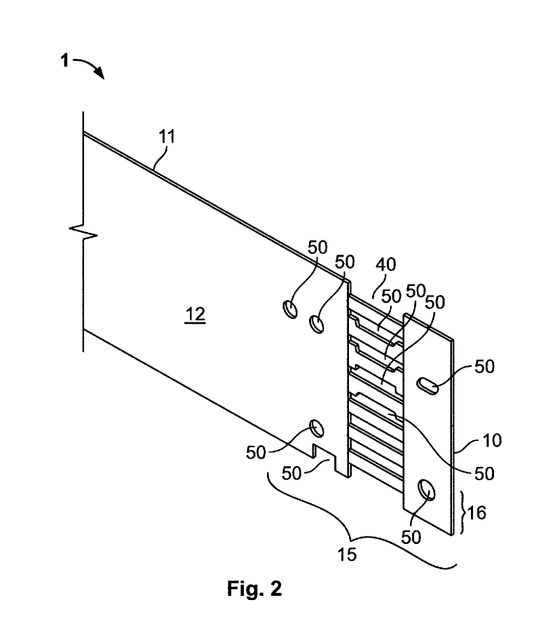

According to the invention, an orientation marker is incorporated for this purpose in an electrical cable 1, shown in FIGS. 1 and 2 of the drawings, especially an electrical flat cable 1. This orientation marker may be configured or provided in any desired portion or region of the flat cable 1. However, as best shown in FIG. 2 orientation markers are disposed in a longitudinal end portion 15 of the flat cable 1.

The orientation marker according to the invention has at least one recess 50. A recess 50 of this type is a molding (indicated in broken lines at the bottom of FIG. 1 on the flat cable 1 as a rectangular longitudinal molding) on the flat cable 1 or preferably a through recess 50 which is, in an exemplary embodiment of the invention, punched into the flat cable 1.

The term “recess 50”, as used hereinafter, refers to any kind of removal of material from a flat cable 1. This is, in particular, removal of any kind of initial contour of the flat cable 1, for example that of a flat conductor 20, hereinafter referred to as flat conductor 20, and/or an electrical insulating material 30, or an indentation or else a contour, produced by the removal of material, on the flat cable 1 (shown in the top left-hand corner of FIG. 1 on the flat cable 1).

In addition, it is possible to provide the orientation marker according to the invention by adding material to the flat cable 1, as may be seen in FIG. 1, for example, on the lower edge of the flat cable 1. Material may be added to a flat cable 1 in this way, inter alia, using a slide in an extrusion process for manufacture of the flat cable 1.

The orientation marker according to the invention is preferably located on/in or in proximity to a stripped region 40, herein referred to as a window 40, of the flat cable 1. This window 40 is used for electrically connecting the flat cable 1.

Furthermore, the orientation marker according to the invention is generally to be provided in or on the flat cable 1 so as to be positioned not completely symmetrically with respect to an axis L, Q of the flat cable 1, said axes mapping onto one another at least two regions and/or outer edges of the flat cable 1.

The orientation marker according to the invention has at least one recess 50. Three recesses 50 in the form of indentations are thus provided, for example, in a lower longitudinal edge region 16 of the flat cable 1. Each one of these three indentations may be regarded as a single orientation marker according to the invention. An exemplary embodiment of the invention has a recess 50 on a transverse end 11 of the flat cable 1. In this case the recess 50 is also located in a transverse edge region 19 of the flat cable 1 (shown in the bottom right-hand corner of FIG. 1 on the flat cable 1). The shape of the recesses 50 is in this case, in principle, immaterial. In this case, the recesses 50 are partially circular or rectangular. Also optionally provided as orientation markers on an upper portion (FIG. 1) of the flat cable 1 are, again in the edge region 16 (starting from the left-hand side), are recesses 50 in the form of a waved contour, a triangular indentation, a clipped corner (on the left-hand side of the window 40) or a longitudinal recess 50.

It is also possible to form the orientation marker according to the invention by a recess 50 in the flat conductor 20. This is possible either in the electrical insulating material 30 of the flat cable 1 (elliptical recess 50 on the right-hand side, next to the window 40 of FIG. 1) or else in the window 40. In the illustrated embodiment of FIG. 1, a plurality of recesses 50 are provided in the window 40 of the flat conductors 20, wherein each individual recess 50 may form an orientation marker. However, it is also possible to combine a plurality of the recesses 50 to form an orientation marker. Thus, for example, a recess 50 is provided with a tapering contour on a flat conductor 20. This contour may be provided on the flat conductor 20 on one side (above or below with regard to FIG. 1) or on both sides (above and below). Furthermore, a flat conductor 20 of this type may have, for example, rectangular or partially circular recesses 50 (second flat conductor 20 from the bottom), for example in the form of punched recesses 50.

In addition, it is possible to provide an orientation marker according to the invention in a region of the electrical insulating material 30 and/or in a region of a flat conductor 20. This may be, for example, a recess 50 which is in the form, for example, of a slot in a longitudinal central region of the flat cable 1 and is shown in FIG. 1 above a longitudinal axis L of the flat cable 1, in proximity to the longitudinal end 10 thereof in FIG. 1.

The orientation marker used may also, for example, be a recess 50 in the form of a punched ellipse shown in FIG. 1 in the bottom left-hand corner with respect to the slot (in all cases, in relation to FIG. 1). FIG. 1 also shows a further orientation marker which is a recess 50 formed on the right-hand side of the ellipse and is in the form of a punched hole which has a circular cross-section and extends exclusively through the electrical insulating material 30. The orientation marker may, according to the invention (in contrast to the elliptical recess 50 shown in FIG. 1) extend not through a flat conductor 20 of the flat cable 1 but rather merely through the electrical insulating material 30, as otherwise the current-carrying capacity of the respective flat conductor 20 is restricted.

In addition, it is possible to form the orientation marker from a plurality of recesses 50. A large number of embodiments of the invention are possible in this case. Thus, for example, it is possible to provide punched holes asymmetrically with respect to a surface center point M of a longitudinal side 12, a transverse axis Q and/or the longitudinal axis L of the flat cable 1. This is illustrated, for example, in the right-hand region of FIG. 1 by the recess 50 formed as a slot and the recess 50 formed as a circular hole, a distance a from the slot to the longitudinal axis L being less than a distance b from the circular hole to the longitudinal axis L. It is, in this case, possible to form the slot as a circular hole or the circular hole as a slot. Furthermore, it is possible, for example, to provide a differing number of recesses 50 in the form of punched holes above and below the longitudinal axis L or a center point M of the flat cable 1. This is illustrated in a central region of FIG. 1.

Obviously, the above-mentioned possibilities may be combined with one another.

Generally, for all embodiments of the invention, a molding, a recess 50 or a through recess 50 may be of any desired shape provided that its respective position and/or other shape allows a flat cable 1 to be positioned in all cases with correct orientation (for a predetermined assembly rule).

According to the invention, the orientation marker is preferably located on/in or in proximity to the window 40 of the flat cable 1. According to the invention, this allows the orientation marker to be provided immediately during manufacture of the flat cable 1. This is carried out, for example, using what is known as the window 40 method which punches a window 40 into one or both cover sheets of a flat cable 1 to be produced by lamination. There is provided in this case, in addition to the window 40 stamp or stamps, at least one further stamp which punches the orientation marker into one or both cover sheets. This may also be provided using a single punching stamp having at least two stamped elevations.

In addition, other methods for stripping the window 40 are also suitable for providing the orientation marker according to the invention. For example, during scraping, grinding and milling, this is possible because of an additional machining step or by omitting a corresponding machining region. Thus, during stripping, it is, for example, possible, as shown on the window 40 at the top of FIG. 1, to provide a recess 50 in a corner or a recess 50 in an edge region of the window 40. Also suitable is a laser method for stripping, which method provides in the flat cable 1 the desired number of recesses 50 in the orientation marker. It is also possible, as shown on the window 40 on the left-hand side of FIG. 1, to leave a recess 50 formed as a projection during stripping.

Furthermore, one or more recesses 50 in the orientation marker may be used as positioning recesses 50 for receiving pins for guiding a counterpart component. According to the invention, this allows the flat cable 1, on the one hand, to be correctly positioned and, on the other hand, to be provided with correct orientation, for example in a connector or during electrical connection to a component.

For the sake of optimally simple visual and/or tactile positioning of the flat cable 1, the orientation marker may be provided, for example, on an edge region 16, 19 remote from an axis L, Q or a center point M of the flat cable 1. Furthermore, the orientation marker according to the invention is may provided in/on or in proximity to the window 40 of the flat cable 1.

The invention is advantageous in the case of cables subjected to a punching or cutting process during manufacture thereof. This is the case, in particular, with flat cables 1 which are cut or punched, for example on cutting-to-length or during manufacture thereof. A punching process of this type is carried out, for example, during manufacture of a flat cable 1 using what is known as a window 40 method in which a flat cable 1 to be laminated is subjected to a punching process prior to adhesion of two insulating layers using at least one window 40 stamp. In this case, one or both insulation films to be adhered is/are punched, the flat cable 1 subsequently not being electrically insulated in the punched region. The invention therefore allows the provision of a recess 50 according to the invention on/in the flat cable 1 using an additional punching tool as well as a window stamp or an otherwise configured window stamp. A laminated flat cable 1 gives rise merely to one-off additional costs resulting from minimal additional expenditure in the production of a new punching tool. According to the invention, it is thus possible to convert an existing cable production line so as to allow the orientation marker according to the invention to be provided in/on the cable. Instead of imprinting or affixing a sticker, recesses or through-recesses, the shape, number or position of the recesses on/in the cable being variable, provide correctly oriented installation of the cable.

The foregoing illustrates some of the possibilities for practicing the invention. Many other embodiments are possible within the scope and spirit of the invention. It is, therefore, intended that the forgoing description be regarded as illustrative rather than limiting, and that the scope of the invention is given by the appended claims together with their full range of equivalents.

What is claimed is:

1. An electrical cable comprising an orientation marker, wherein the orientation marker has at least one recess in the electrical cable, which recess is provided in the electrical cable so as to allow correct alignment of the electrical cable during installation and/or manufacture of the electrical cable.

2. The electrical cable according to claim 1, wherein correct alignment of the electrical cable is facilitated visually and/or tactilely by the orientation marker in the electrical cable.

3. The electrical cable according to either claim 2, wherein the orientation marker is provided in the electrical cable in such a way that it cannot fully be mapped onto itself with respect to an axis of symmetry or a center point of the electrical cable.

4. The electrical cable according to claim 2, wherein the recess is at least partially elliptical.

5. The electrical cable according to claim 2, wherein the recess is at least partially circular

6. The electrical cable according to claim 2, wherein the recess is substantially rectangular

7. The electrical cable according to claim 2, wherein the recess is substantially square.

8. The electrical cable according to claim 2, wherein the recess is a through-recess.

9. The electrical cable according to claim 2, wherein the orientation marker has an indentation in a longitudinal edge region or transverse edge region of the electrical cable.

10. The electrical cable according to claim 2, wherein the orientation marker has a plurality of recesses, and at least two recesses differ in shape.

11. The electrical cable according to claim 10, wherein the at least two recesses are arranged asymmetrically with respect to a longitudinal axis of the electrical cable.

12. The electrical cable according to claim 3, wherein on two opposing sides of the axis of symmetry or the center point of the electrical cable there are respectively provided a differing number of recesses which jointly form the orientation marker.

13. The electrical cable according to claim 2, wherein one of the recesses is provided at least partially in an electrical conductor of the electrical cable.

14. The electrical cable according to claim 13, wherein one of the recesses is provided at least partially in an electrical insulation material of the electrical cable.

15. The electrical cable according to claim 13, wherein a recess is located in a window of the electrical cable and is formed as a taper in the electrical conductor.

16. The electrical cable according to claim 2, wherein the orientation marker is provided in proximity to a window of the electrical cable.

17. The electrical cable according to claim 2, wherein the at least one recess acts as a positioning hole for receiving a guide pin which is provided on a component to which the electrical component can be connected.

18. A coil spring for a motor vehicle, comprising a flexible flat electrical cable, having an orientation marker, the orientation marker having at least one recess in the electrical cable which recess is provided in the electrical cable so as to allow correct alignment of the electrical cable during installation and/or manufacture thereof.
